(19) United States
(12) Patent Application Publication
(10) Pub. No.: US 2025/0186962 A1
(43) Pub. Date: Jun. 12, 2025

(54) REACTOR AND USE OF REACTOR FOR CONVERTING CHEMICAL COMPOUNDS INTO MATERIALS, GASES OR ENERGY

(71) Applicant: D-CRBN BV, Antwerp (BE)

(72) Inventors: Georgi TRENCHEV, Antwerp (BE); Gill SCHELTJENS, Wilrijk (BE); David ZIEGLER, Antwerp (BE)

(21) Appl. No.: 18/845,316

(22) PCT Filed: Mar. 10, 2023
(86) PCT No.: PCT/EP2023/056118

§ 371 Date: Sep. 9, 2024

(30) Foreign Application Priority Data
Mar. 11, 2022 (BE) BE2022/5171

(51) Int. Cl. B01J 19/08; B01J 19/24

(52) U.S. Cl. CPC B01J 19/088; B01J 19/2405; B01J 19/242; B01J 2219/0807; B01J 2219/0845; B01J 2219/0869; B01J 2219/0875; B01J 2219/0894

(57) ABSTRACT

The current invention relates to a reactor module for converting chemical compounds into materials, gases or energy, wherein the reactor module is suitable for axial stacking, comprising: one or more reaction chambers, one or more exhaust channels, and one or more flow channels for conducting a flow of reactant gas comprising chemical compounds, wherein, said flow channel is connected to one or more reaction chambers by a tangential channel, wherein said tangential channel is connected to the reaction chamber tangentially to its circular cross-section, and wherein said tangential channel is suitable for directing the flow of reactant gas or part of the flow of reactant gas into the reaction chamber. The invention also relates to a reactor stack comprising two or more aforementioned reactor modules axially stacked. The invention also relates to the use of aforementioned module or a stack of modules for gas conversion.

### FIELD OF THE INVENTION

The present invention relates to a reactor module for converting chemical compounds into materials, gases or energy.

In a second aspect, the present invention also relates to a reactor stack comprising two or more reactor modules axially stacked.

In another aspect, the present invention also relates to a use of aforementioned module or reactor stack for gas conversion.

### BACKGROUND

Plasma reactors, thermal or combustion chambers are used to convert chemical compounds into materials, gases or energy. In order to fulfil performance criteria, these devices need certain optimizations, which lead to complex geometrical structures, and/or addition of elements such as catalysts and co-reactants. Due to specific constraints, linear upscaling of these devices or reactors may be costly or simply not feasible.

Plasma reactors are known, for example from U.S. Pat. No. 7,919,053B2. However, this known reactor is not suited for linear upscaling.

US20100258429 describes a system using solar thermal energy coupled with microwaves and plasma for the production of carbon monoxide (CO) and dihydrogen (H2) from carbonaceous compounds (biomass, municipal waste, wastewater sludge, fossil coal), wherein the gaseous mixture obtained yields, among other things, hydrocarbon fuels (olefins, kerosenes), esters and alcohols via a Fischer-Tropsch synthesis.

US20150041454 describes a plasma system comprising a plasma arc torch, a cylindrical tube, and an eductor.

The present invention aims to resolve at least some of the problems and disadvantages mentioned above. The aim of the invention is to provide a method which eliminates those disadvantages. The present invention targets at solving at least one of the aforementioned disadvantages.

### SUMMARY OF THE INVENTION

The present invention and embodiments thereof serve to provide a solution to one or more of above-mentioned disadvantages. To this end, the present invention relates to a reactor module for converting chemical compounds into materials, gases or energy according to claim 1.

Preferred embodiments of the device are shown in any of the claims 2 to 10.

In a second aspect, the present invention relates to a reactor stack according to claim 11.

Preferred embodiments of the method are shown in any of the claims 11 to 15.

In a third aspect the present invention relates to a use of aforementioned reactor module or reactor stack for gas conversion according to claim 16.

Preferred embodiments of the method are shown in any of the claims 16 to 18.

It is a prime objective of the present invention to overcome abovementioned disadvantages of the prior art by providing a reactor design, allowing for massive parallelization or serialization of multiple reactors sharing vortex flow stabilization, atmospheric plasma discharge and/or a common catalyst/co-reactant. The reactor module and reactor stack allow for a broad range of configurations, including a combination of different type of reactors, heat exchangers, gas separators, etc.

### DESCRIPTION OF FIGURES

The following numbering refers to:
1 Reactor module
2 Exhaust channel
3 Flow channel
4 Axial direction
5 Reaction chamber
6 Radial direction
7 Electrode plug
8 Connection between reaction chamber and exhaust channel
9 Tangential channel
10 Distal side of reactor module
11 Proximal side of reactor module
12 Reactor stack
13 Interconnecting exhaust channel
14 Interconnecting flow channel
15 Pressure chamber
16 Reactant gas
17 Exhaust product
18 Reactant gas
19 Inner wall of pressure chamber
20 Inner volume of pressure chamber
21 Outer wall of pressure chamber
22 Rotatable screw
23 Grooves of rotatable screw
24 Insulation ring
25 Pressure chamber inlet

The following description of the figures of specific embodiments of the invention is merely exemplary in nature and is not intended to limit the present teachings, their application or uses. Throughout the drawings, corresponding reference numerals indicate like or corresponding parts and features.

FIG. 1 shows a perspective view of a reactor module according to an embodiment of the present invention.

FIG. 2 shows a transparent perspective view of a reactor module according to an embodiment of the present invention.

FIG. 3 shows an enlarged view of a reaction chamber and a tangential channel according to an embodiment of the present invention.

FIG. 4 shows a transparent enlarged view of a reaction chamber and a tangential channel according to an embodiment of the present invention.

FIG. 5 shows the flow velocity streamlines in a reactor stack according to an embodiment of the present invention.

FIG. 6 shows a perspective view of a reactor stack according to an embodiment of the present invention.

### DETAILED DESCRIPTION OF THE INVENTION

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

As used herein, the following terms have the following meanings:

“A”, “an”, and “the” as used herein refers to both singular and plural referents unless the context clearly dictates otherwise. By way of example, “a compartment” refers to one or more than one compartment.

“About” as used herein referring to a measurable value such as a parameter, an amount, a temporal duration, and the like, is meant to encompass variations of +/−20% or less, preferably +/−10% or less, more preferably +/−5% or less, even more preferably +/−1% or less, and still more preferably +/−0.1% or less of and from the specified value, in so far such variations are appropriate to perform in the disclosed invention. However, it is to be understood that the value to which the modifier “about” refers is itself also specifically disclosed.

“Comprise”, “comprising”, and “comprises” and “comprised of” as used herein are synonymous with “include”, “including”, “includes” or “contain”, “containing”, “contains” and are inclusive or open-ended terms that specifies the presence of what follows e.g. component and do not exclude or preclude the presence of additional, non-recited components, features, element, members, steps, known in the art or disclosed therein.

Furthermore, the terms first, second, third and the like in the description and in the claims, are used for distinguishing between similar elements and not necessarily for describing a sequential or chronological order, unless specified. It is to be understood that the terms so used are interchangeable under appropriate circumstances and that the embodiments of the invention described herein are capable of operation in other sequences than described or illustrated herein.

The recitation of numerical ranges by endpoints includes all numbers and fractions subsumed within that range, as well as the recited endpoints.

The expression “% by weight”, “weight percent”, “% wt” or “wt %”, here and throughout the description unless otherwise defined, refers to the relative weight of the respective component based on the overall weight of the formulation.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any ≥3, ≥4, ≥5, ≥6 or ≥7 etc. of said members, and up to all said members.

Unless otherwise defined, all terms used in disclosing the invention, including technical and scientific terms, have the meaning as commonly understood by one of ordinary skill in the art to which this invention belongs. By means of further guidance, definitions for the terms used in the description are included to better appreciate the 15 teaching of the present invention. The terms or definitions used herein are provided solely to aid in the understanding of the invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

The expressions “gliding arc (GA)”, “glow discharge”, “radiofrequency plasma (RF)”, “microwave plasma (MW)”, “inductively coupled plasma (ICP)”, “capacitive coupled plasma (CCP)” and “dielectric barrier discharge (DBD)”, as used in the text, refer to plasma generating means as would be understood by those in the art.

In a first aspect, the invention relates to a reactor module for converting chemical compounds into materials, gases or energy, wherein the reactor module is suitable for axial stacking.

In a particularly preferred embodiment of the invention, the reactor module comprises:
one or more reaction chambers, wherein the reaction chamber has a cylindrical shape characterized by a circular cross-section;
one or more exhaust channels, wherein the exhaust channels extend in the axial direction;
one or more flow channels for conducting a flow of reactant gas comprising chemical compounds, wherein the flow channels extend in the axial direction;

In this embodiment of the invention, said flow channel is connected to one or more reaction chambers by a tangential channel, wherein said tangential channel is connected to the reaction chamber tangentially to its circular cross-section, and wherein said tangential channel is suitable for directing the flow of reactant gas or part of the flow of reactant gas into the reaction chamber.

The tangential flow channel is suitable as a swirl generator for the gas flow. The tangential channel will allow the gas to enter the discharge chamber tangentially, where it forms a forward or a reverse vortex flow pattern. This pattern is known to improve the discharge efficiency and stability.

The reactor module of the current invention is suitable to be used as sole reactor or in a combination with similar reactor modules in an axial stack.

Said reactor module has a cylindrical shape characterized by a circular cross-section preferably with a diameter of 50-1000 mm, more preferably with a diameter of 100-500 mm, even more preferably with a diameter of 150-200 mm.

Said exhaust channel can have a cylindrical shape characterized by a circular cross-section with a diameter of 20-200 mm, preferably 50-70 mm, more preferably 55-65 mm.

Said reaction chamber can have a cylindrical shape characterized by a circular cross-section with a diameter of 3-100 mm, preferably 5-50 mm, even more preferably 6-8 mm.

In a preferred embodiment, said reaction chamber has a length of 5-150 mm, preferably 10-100 mm, more preferably 15-30 mm.

In a preferred embodiment of the invention, the one or more reaction chambers are connected to one exhaust channel, wherein said exhaust channel is preferably positioned in the center of the reactor module, preferably said reaction chamber and said exhaust channel are positioned perpendicular to each other.

In a preferred embodiment of the invention, the one or more reaction chambers are radially oriented at 360/n degrees angle respect to each other, wherein n is the number of reaction chambers, preferably n is an even number.

In a preferred embodiment of the invention, the reactor module comprises 2, 3, 4, 5 or 6 reaction chambers, preferably 2, 4 or 6 reaction chambers, more preferably 4 reaction chambers.

In a more preferred embodiment of the invention the reactor module comprises 4 reaction chambers, wherein the reaction chambers are radially oriented at 90 degrees angle respect to each other.

In an embodiment of the invention, the reaction chambers can be inclined upwards or downwards with respect to the reactor module radial cross-section, at an angle of −90 to 90 degrees, preferably −45 to 45 degrees.

In a preferred embodiment of the invention, the reaction chambers are provided with an insulated electrode plug suitable for driving the reaction chamber by combustion, chemical reactions or plasma generation, preferably the insulated electrode plugs are aligned with the axis of the cylindrical reaction chamber.

In a preferred embodiment of the invention, each reaction chamber is connected to one flow channel, wherein each flow channel is connected to one reaction chamber, preferably said flow channel and said reaction chamber are positioned perpendicular to each other.

In a preferred embodiment of the invention, the reaction chambers comprise plasma generating means, said means chosen from the list of:
gliding arc (GA)
glow discharge
radiofrequency plasma (RF)
microwave plasma (MW)
inductively coupled plasma (ICP)
capacitive coupled plasma (CCP)
dielectric barrier discharge (DBD).

In a more preferred embodiment of the invention, the reaction chambers comprise plasma generating means, said means chosen from the list of:
gliding arc (GA)
glow discharge
radiofrequency plasma (RF)
microwave plasma (MW).

In an even more preferred embodiment of the invention, the reaction chambers comprise plasma generating means, said means being gliding arc (GA).

In a preferred embodiment of the invention, the reactor module further comprises one or more heat exchangers, preferably one or more heat exchange pipes suitable for operating with gas or liquid.

In another preferred embodiment of the invention, the heat exchanger is a heatsink suitable for convectional (free-flowing) or forced cooling.

In a preferred embodiment of the invention, the flow channel connects the distal side of the reactor module to the proximal side of the reactor module, preferably said flow channels extend in the axial direction.

In a preferred embodiment of the invention, the flow channel connects the distal side of the reactor module to the proximal side of the reactor module, preferably said flow channels extend in the axial direction, parallel to the exhaust channel.

In a preferred embodiment of the invention, the reactor module further comprises a pressure chamber, which is mounted on the distal side of the reactor module and which is connected to the one or more reaction chambers by a flow channel and a tangential channel, suitable for distributing the flow of reactant gas to the tangential channels.

The pressure chamber is suitable as gas input to any of the flow channels tangential channels, and reaction chambers.

The reactor module is made from any suitable material, such as metals, plastics and ceramics, preferably the reactor module is made from high-temperature steel. Alternatively, the reactor module is made from a combination of materials.

The electrode plug can be manufactured from glass, PTFE and ceramic alternatives. So, a high degree of electrical insulation is achieved.

In a second aspect, the invention relates to a reactor stack comprising two or more aforementioned reactor modules axially stacked.

In a particularly preferred embodiment of the invention, the flow channels and the exhaust channels are aligned in between the reactor modules, so an interconnecting exhaust channel and interconnecting flow channels are formed.

In a preferred embodiment of the invention, the reactor stack comprises two or more identical aforementioned reactor modules axially stacked.

In a preferred embodiment of the invention, the stack of reactor modules is equipped with one pressure chamber suitable for distributing the flow of reactant gas to any reaction chamber in the stack of reactor modules.

In this embodiment the pressure chamber is axially stacked on the distal or proximal side of the stack of reactor modules, preferably on the distal side of the stack.

In another embodiment of the invention, individual pressure chambers can be provided for each interconnecting channel.

In an embodiment of the invention, the interconnecting exhaust channel is provided with a transport mechanism, such as but not limited to a rotatable screw, a transport belt or a vertical silo suitable for supplying catalysts or reactants in a solid and/or liquid state to the stack, more preferably the interconnecting exhaust channel is provided with a rotatable screw.

A transport mechanism can supply catalyst or other co-reactants to the reactor stack, as it allows a direct contact with the active plasma and/or flame. A rotating screw can supply solid material in the reactor body at a controllable rate. Additionally, this material may be liquid, or a certain mixture of both. In this way, uniform catalyst treatment can be achieved, as well as a continuous supply. Additionally, using a screw configuration is beneficial for managing gas leaks.

In another embodiment of the invention, the interconnecting exhaust channel is provided with a heat exchanger. In this embodiment the heat exchanger is suitable for managing the heat recovery of the reactor stack.

In a preferred embodiment of the invention, the reactor stack comprises maximum 35 reactor modules, preferably maximum 30 reactor modules, more preferably 20 reactor modules. This amount of reactor modules allows or convectional cooling, which reduces the amount of energy needed for cooling the reactor stack.

In another preferred embodiment of the invention, the reactor stack comprises between 30 and 1000 reactor, preferably between 50 and 500 reactor modules, more preferably between 50 and 100 reactor modules. This amount of reactor modules allows to process large volumes and increase conversion.

In a third aspect, the invention relates to a use of aforementioned reactor module or aforementioned stack of modules for gas conversion.

In a preferred embodiment, the gas may be flue gas, waste gas from combustion, CO₂, CO, CH₄, H₂, and/or any combinations thereof, including impurities such as H₂O and SO₂.

In a more preferred embodiment of the invention, the gas comprises more than 98% CO₂ by weight. In another preferred embodiment of the invention, the gas comprises CO₂ and CH₄ in a ratio by weight of at most 4/1, more preferably at most 3/1, more preferably at most 2/1, more preferably at most 1/1. In another preferred embodiment of the invention, the gas comprises CO₂ and CH₄ in a ratio by weight of at least ¼, more preferably at least ⅓, more preferably at least ½, more preferably at least 1/1. In another embodiment, the gas comprises CO₂ and CH₄ in a ratio between 4/1 and ¼, more preferably in a ratio between 3/1 and ⅓, more preferably in a ratio between 2/1 and ½, most preferably in a ratio of about 1/1.

In a preferred embodiment of the invention, the gas conversion is carried out by plasma generation in the one or more reaction chambers.

In a particularly preferred embodiment, the gas comprises CO₂.

In this embodiment of the invention, the plasma is generated by a plasma generating means chosen from the list of:
gliding arc (GA)
glow discharge
radiofrequency plasma (RF)
microwave plasma (MW)
inductively coupled plasma (ICP)
capacitive coupled plasma (CCP)
dielectric barrier discharge (DBD).

Preferably, the plasma is generated by a plasma generating means chosen from the list of:
gliding arc (GA)
glow discharge
radiofrequency plasma (RF)
microwave plasma (MW).

More preferably, the plasma is generated by a plasma generating means, said means being gliding arc (GA).

In an another particularly preferred embodiment, the gas comprises CH₄.

In this embodiment of the invention, the plasma is generated by a plasma generating means chosen from the list of:
glow discharge
gliding arc (GA)
dielectric barrier discharge (DBD)
microwave plasma (MW)
radiofrequency plasma (RF)
inductively coupled plasma (ICP)
capacitive coupled plasma (CCP).

Preferably, the plasma is generated by a plasma generating means chosen from the list of:
glow discharge
gliding arc (GA)
dielectric barrier discharge (DBD)
microwave plasma (MW).

More preferably, the plasma is generated by a plasma generating means, said means being glow discharge.

In this embodiment, the gas comprises CH₄, wherein the CH₄ converted to syngas and/or H₂.

In a preferred embodiment of the invention, the flow rate of the reactant gas in each reaction chamber is comprised between 1 and 100 L/min, preferably between 10 and 30 L/min.

In an embodiment of the invention, each reactor module may be operated at a power value of 0.1-100 kW, preferably each reactor module may be operated at a power value of 1-10 KW, more preferably each reactor module may be operated at a power value of 1 kW.

Gliding arc (GA) and glow discharge plasma generating means can be powered by AC, AC pulsed, DC pulsed and DC power supplies with a linear or switching conversion topology.

DBD, ICP, RF and MW plasma generating means can be powered via the means of a solid-state generator coupled with a high-frequency amplifier, or, alternatively, by a magnetron (MW).

The invention is further described by the following non-limiting examples which further illustrate the invention, and are not intended to, nor should they be interpreted to, limit the scope of the invention.

### EXAMPLES AND DESCRIPTION OF FIGURES

With as a goal illustrating better the properties of the invention the following presents, as an example and limiting in no way other potential applications, a description of a number of preferred applications of the method for examining the state of the grout used in a mechanical connection based on the invention, wherein:

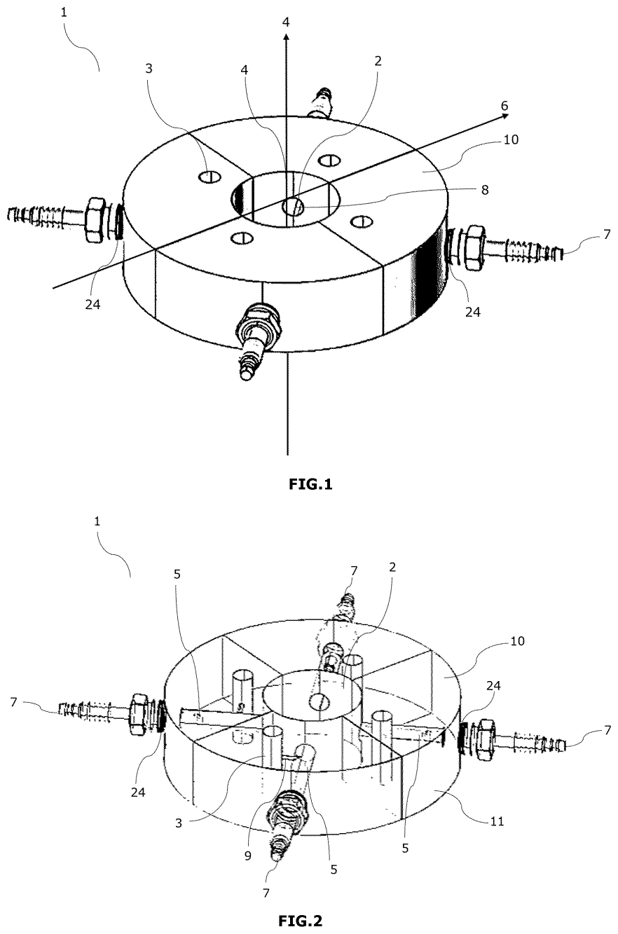

FIG. 1 shows a perspective view of a reactor module according to an embodiment of the present invention.

FIG. 2 shows a transparent perspective view of a reactor module according to an embodiment of the present invention.

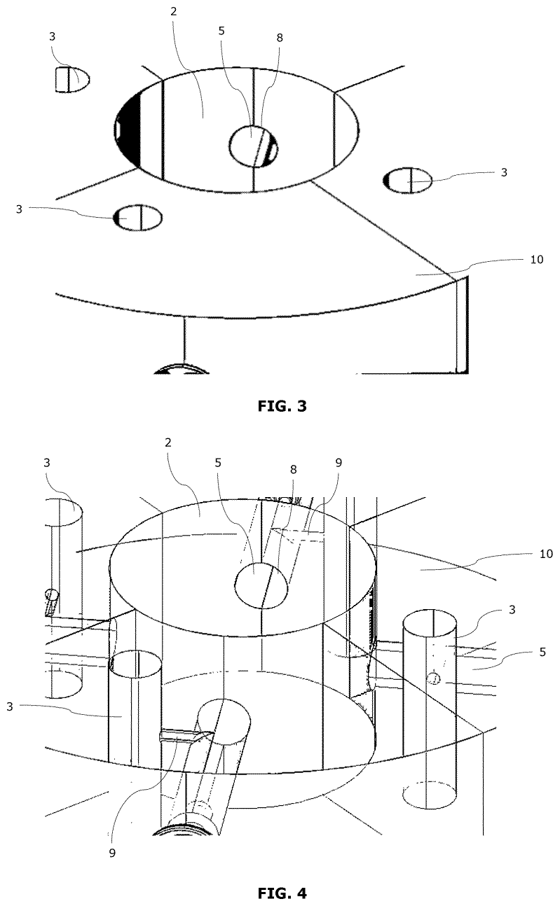

FIG. 3 shows an enlarged view of a reaction chamber and a tangential channel according to an embodiment of the present invention.

FIG. 4 shows a transparent enlarged view of a reaction chamber and a tangential channel according to an embodiment of the present invention.

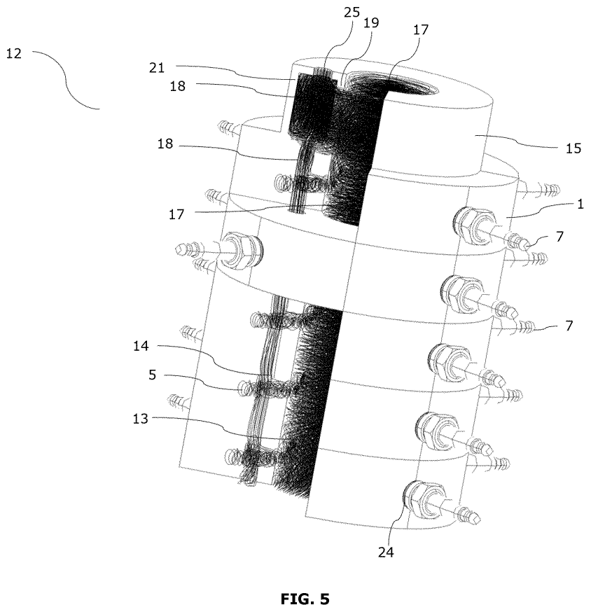

FIG. 5 shows a flow calculation of a reactor stack according to an embodiment of the present invention.

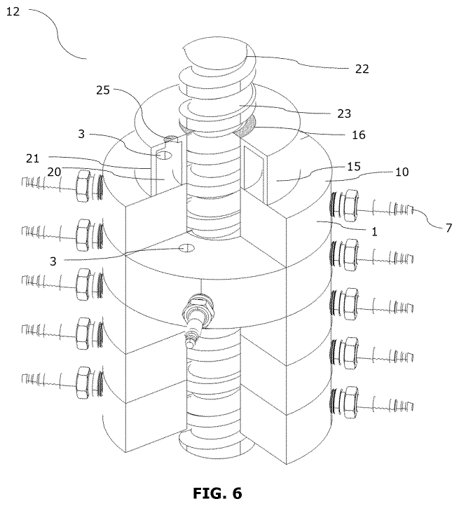

FIG. 6 shows a perspective view of a reactor stack according to an embodiment of the present invention.

In an embodiment of the present invention, a reactor module 1 has a central exhaust channel 2 and four flow channels 3, parallel to the exhaust channel 2. The exhaust channel 2 and flow channels 3 extend in the axial direction 4. The reactor module 1 comprises four reaction chambers 5, wherein the reaction chambers 5 extend in the radial direction 6 at ninety degrees angle respect to each other. In each reaction chamber 5 electrode plugs 7 are aligned with the axis of the cylindrical reaction chamber 5, which is aligned with the radial direction 6 of the reactor module 1. The electrode plugs 7 are insulated by an insulation ring 24 The reaction chambers 5 are connected 8 to the exhaust channel 2. The reaction chambers 5 are connected to the flow channels by tangential channels 9, wherein said tangential channel is connected to the reaction chamber tangentially to its circular cross-section. The flow channels 3 connect the distal side 10 of the reactor module to the proximal side 11 of the reactor module.

In an embodiment of the present invention, the reactor stack 12 consists of five axially stacked (according to the axial direction 4) reactor modules 1. The exhaust channel 2 and the flow channels 3 of each reactor module 1 are aligned in between the reactor modules 1, so an interconnecting exhaust channel 13 and interconnecting flow channels 14 are formed. The reactor stack 12 is equipped with a pressure chamber 15, which serves as gas input to the interconnecting flow channels 14, suitable for distributing the flow of reactant gas 16 to any reaction chamber 5 in the reactor stack 12.

In this embodiment the pressure chamber 15 is axially stacked (according to the axial direction 4) on the distal side 10 of the most distal reactor module in the stack of reactor modules. The pressure chamber 15 is donut-shaped with a cylindrical opening 16, which has a circular cross-section that is the same size as the circular cross-section of the interconnecting exhaust channel 13. The interconnecting exhaust channel 13 thus extends axially 4 through the pressure chamber 15, wherein the exhaust product 17 and the reactant gas 18 are separated by the inner wall 19 of the pressure chamber 15. The pressure chamber 15 has an inner volume 20 between the inner wall 19 and outer wall 21 wherein the reactant gas 18 resides.

Said inner volume 20 is fluidly connected to the four interconnected flow channels 14. The pressure chamber 15 has a pressure chamber inlet 25, through which the reactant gas is supplied.

The reactor modules 1 in the reactor stack 12 are axially stacked (according to the axial direction 4), wherein the distal side 10 of a reactor module is connected to the proximal side 11 of a contiguous reactor module 1.

The interconnecting exhaust channel 13 is provided with a rotatable screw 22, which consists of grooves 23 suitable for carrying solid or liquid reactants or catalysts through the interconnecting exhaust channel 13.

In FIGS. 5 and 6, some entities of the reactor stack according to an embodiment of the present invention are hidden to improve visibility in the figures.

The present invention will now be further exemplified with reference to the following example. The present invention is in no way limited to the given example or to the embodiments presented in the figures.

### Example 1: Flow Calculation of Reactant Gas and Product Gas

Example 1 refers to a flow calculation performed on a reactor stack according to an embodiment of the present invention. Results show that the flow velocity varies between 5 and 30 m/s. Also, the vortex flow streamlines in the reaction chambers are calculated.

The flow pattern reveals the gas distribution and vortex formation in the reaction chambers. No preferential flow is observed for a stack of five, whereas such can be expected with longer stacks. In such case, the vertical channel diameter should be increased.

To better exemplify reference is made to FIG. 5, which shows the flow velocity streamlines that resulted from the flow calculation of a reactor stack according to an embodiment of the present invention.

The present invention is in no way limited to the embodiments described in the examples and/or shown in the figures. On the contrary, methods according to the present invention may be realized in many different ways without departing from the scope of the invention.

1. A reactor module for converting chemical compounds into materials, gases or energy, wherein the reactor module is suitable for axial stacking, comprising:
one or more reaction chambers, wherein the one or more reaction chambers have a cylindrical shape characterized by a circular cross-section,
one or more exhaust channels, wherein the one or more exhaust channels extend in an axial direction,
and one or more flow channels for conducting a flow of reactant gas comprising chemical compounds, wherein the one or more flow channels extend in the axial direction,
characterized in that,
said one or more flow channels are connected to one or more reaction chambers by a tangential channel, wherein said tangential channel is connected to the one or more reaction chambers tangentially to its circular cross-section, and wherein said tangential channel is suitable for directing the flow of reactant gas or part of the flow of reactant gas into the one or more reaction chambers.

2. The reactor module according to claim 1, wherein the one or more reaction chambers are connected to at least one of the one or more exhaust channels, wherein said one or more exhaust channels are positioned in a center of the reactor module, wherein said one or more reaction chambers and said one or more exhaust channels are positioned perpendicular to each other.

3. The reactor module according to claim 2, wherein the one or more reaction chambers are radially oriented at 360/n degrees angle respect to each other, where n is the number of the one or more reaction chambers.

4. The reactor module according to claim 1, wherein the reactor module comprises 2, 3, 4, 5 or 6 reaction chambers.

5. The reactor module according to claim 1, wherein the one or more reaction chambers are provided with an one or more insulated electrode plugs suitable for driving the one or more reaction chambers by combustion, chemical reactions, or plasma generation, and wherein the one or more insulated electrode plugs are optionally aligned with the axis of the cylindrical one or more reaction chambers.

6. The reactor module according to claim 1, wherein each of the one or more reaction chambers is are connected to the one or more flow channels, wherein each of the one or more flow channels is are connected to the one or more reaction chambers, and wherein said one or more flow channels and said one or more reaction chambers are positioned perpendicular to each other.

7. The reactor module according to claim 1, wherein the one or more reaction chambers comprise plasma generating means, said means chosen from:
gliding arc (GA);
glow discharge;
radiofrequency plasma (RF);
microwave plasma (MW);
inductively coupled plasma (ICP);
capacitive coupled plasma (CCP); or
dielectric barrier discharge (DBD).

8. The reactor module according to claim 1, wherein the reactor module further comprises one or more heat exchangers, having one or more heat exchange pipes suitable for operating with gas or liquid.

9. The reactor module according to claim 1, wherein the one or more flow channels connect a distal side of the reactor module to a proximal side of the reactor module, and wherein said one or more flow channels extend in the axial direction.

10. The reactor module according to claim 9, wherein the reactor module further comprises at least one pressure chamber, which is mounted on the distal side of the reactor module and which is connected to the one or more reaction chambers by the one or more flow channels and a tangential channel, suitable for distributing the flow of reactant gas to the tangential channels.

11. A reactor stack comprising two or more reactor modules according to claim 10 axially stacked, wherein the one or more exhaust channels and the one or more flow channels are aligned in between the two or more reactor modules, so an interconnecting one or more exhaust channels and interconnecting one or more flow channels are formed.

12. The reactor stack according to claim 11, wherein the reactor stack of reactor modules is equipped with the at least one pressure chamber suitable for distributing the flow of reactant gas to any reaction chamber in the reactor stack of reactor modules.

13. The reactor stack according to claim 12, wherein the at least one pressure chamber is axially stacked on the distal or the proximal side of the stack of reactor modules.

14. The reactor stack according to claim 11, wherein the interconnecting one or more exhaust channels are provided with a transport mechanism.

15. The reactor stack according to claim 11, wherein the interconnecting one or more exhaust channels is are provided with a heat exchanger.

16. A method of using Use of the reactor module according to claim 1 for gas conversion, wherein the gas may be flue gas, waste gas from combustion, CO₂, CO, CH₄, H₂, and any combinations thereof, including impurities.

17. The method according to claim 16, wherein the gas conversion is carried out by plasma generation in the one or more reaction chambers.

18. The method according to claim 16, wherein a flow rate of the reactant gas in each reaction chamber is comprised between 1 and 100 L/min.
